(19) United States
(12) Patent Application Publication
(10) Pub. No.: US 2025/0319624 A1
(43) Pub. Date: Oct. 16, 2025

(54) BLOCKING ELEMENT FOR AN EMERGENCY BRAKE UNIT OF A SAWING DEVICE AND SAWING DEVICE

(71) Applicant: Festool GmbH, Wendlingen (DE)

(72) Inventors: Josua Frank, Urbach (DE); Jonathan Caputo, Althengstett (DE); Michael Majer, Notzingen (DE); Markus Schmid, Uhingen (DE); Christian Schock, Schorndorf (DE)

(73) Assignee: Festool GmbH, Wendlingen (DE)

(21) Appl. No.: 18/864,333

(22) PCT Filed: May 9, 2023
(86) PCT No.: PCT/EP2023/062288

§ 371 Date: Nov. 8, 2024

(30) Foreign Application Priority Data
May 12, 2022 (EP) 22172995.7

(51) Int. Cl. B27B 5/38; B27G 19/00; B27G 19/02

(52) U.S. Cl. CPC B27B 5/381; B27G 19/008; B27G 19/025

(57) ABSTRACT

A blocking element for an emergency brake unit of a sawing device has a circular disc-shaped saw blade. The blocking element has a bearing portion, via which the blocking element is configured to be mounted on the sawing device, a head portion which is designed to engage into the saw blade selectively for braking purposes, and a deformation portion which is located between the bearing portion and the head portion and/or connects the bearing portion and the head portion to one another and which is arcuate and designed to be plastically shortened to brake the saw blade in an arc circumferential direction. A sawing device has a circular disc-shaped saw blade and an emergency brake unit. The emergency brake unit has such a blocking element which is mounted on the sawing device such that it can engage selectively into the saw blade to brake the saw blade.

The invention relates to a blocking element for an emergency brake unit of a sawing device having a circular disc-shaped saw blade.

The invention also relates to a sawing device having a circular disc-shaped saw blade and an emergency brake unit, wherein the emergency brake unit comprises such a blocking element.

Sawing devices comprising emergency brake units are known from the prior art.

The emergency brake unit and in particular the blocking element it comprises are used to stop rotation of the saw blade if there is a threat of, or an existing, risk of injury. In this manner, injuries to users of the sawing devices are avoided or at least the severity thereof is reduced. In other words, safe operation of the sawing device is ensured.

In this regard, it is important to stop the rotation of the saw blade within a comparatively short time. However, this means that the kinetic energy of the saw blade must be absorbed within this short time by the components of the emergency brake unit and/or the remaining components of the sawing device. Therefore, comparatively large forces act upon the components of the emergency brake unit and/or the remaining components of the sawing device.

This can lead to the fact that, after usage of the emergency brake unit, one or a plurality of components thereof and one or a plurality of components of the sawing device is deformed or otherwise damaged and so they must be replaced before the sawing device can be put back into operation.

Therefore, it is the object of the present invention to provide an emergency brake unit, by means of which rotation of a saw blade can be stopped within a comparatively short time, wherein at the same time the functionality of as few components of the emergency brake unit and/or an associated sawing device as possible is impaired.

The object is achieved by a blocking element for an emergency brake unit of a sawing device having a circular disc-shaped saw blade. The blocking element comprises a bearing portion, via which the blocking element can be supported on the sawing device, in particular in a rotatable manner. Furthermore, the blocking element comprises a head portion which is designed to engage into the saw blade selectively for braking purposes. Moreover, the blocking element comprises a deformation portion which is located between the bearing portion and the head portion and/or connects the bearing portion and the head portion to one another. The deformation portion is arcuate and is designed to be plastically shortened in order to brake the saw blade in an arc circumferential direction. Therefore, the kinetic energy of the rotation of the saw blade can be converted reliably and purposefully into a plastic shortening of the deformation portion. This is achieved in particular by the arc shape of the deformation portion and its position between the bearing portion and the head portion. Consequently, rotation of the saw blade can be stopped in a comparatively short time. Since the deformation portion is specifically designed to be plastically shortened in the arc circumferential direction, it can absorb a comparatively large amount of kinetic energy in relation to the installation space occupied by the deformation portion and convert it into plastic shortening. This also means that forces resulting from the braking of the saw blade are absorbed by the deformation portion in a reliable and targeted manner. As a result, only comparatively small forces act upon the remaining components of the emergency brake unit. The same applies to components of the associated sawing device. Therefore, the remaining components of the emergency brake unit and the components of the sawing device are not influenced in terms of their functional efficiency by an emergency braking procedure brought about by the blocking element. This applies in particular to the saw blade, which can thus continue to be used when the sawing device is put back into operation.

With regard to the arcuate configuration of the deformation portion, it is noted that even deformation portions which are arcuate in sections are to be considered to be arcuate. A deformation portion which is composed of an arcuate segment and a rectilinear segment is thus also an arcuate deformation portion.

An arc shape includes e.g. a circular arc shape or an elliptical arc shape. The part of a circular line associated with a circular surface sector is referred to as a circular arc. Similarly, the part of an ellipse line associated with an ellipse surface sector is referred to as an ellipse arc.

Preferably, the bearing portion and the head portion of the blocking element are provided at opposite ends of the blocking element.

The bearing portion can have a receiver for a bearing element, e.g. a bearing pin. Preferably, a central axis of such a receiver extends in parallel with a central axis allocated to the arc circumferential direction of the deformation portion. Therefore, the blocking element is mounted on the bearing pin so as to be able to rotate via the bearing portion.

Furthermore, an interface for coupling the blocking element to an actuator can be provided on the head portion. The blocking element, more precisely the associated head portion, can thus be brought quickly and reliably into engagement with the saw blade.

Moreover, an interface for retaining the blocking element in a normal position-to be explained hereinafter-can be provided on the head portion. Such retention ensures that the head portion does not engage with the saw blade in an undesired manner.

The interface for coupling the blocking element to an actuator and the interface for retaining the blocking element in the normal position can be formed in a combined or integral manner.

In this regard, a sawing device having a circular disc-shaped saw blade can also be referred to as a circular sawing device or simply as a circular saw. Examples of such sawing devices are mitre saws, circular bench saws, circular hand saws and plunge saws.

Blocking elements for emergency brake units of sawing devices are also known colloquially as brake wedges. This is irrespective of whether the blocking element is wedge-shaped or acts as a wedge.

In a state in which the blocking element is mounted in a sawing device, the arcuate deformation portion can be arranged in particular concentrically to the circular disc-shaped saw blade. In this manner, the blocking element can engage quickly and reliably into the saw blade. Furthermore, the kinetic energy of the rotation of the saw blade can thus be introduced simply and reliably into the blocking element and in particular the deformation portion. Moreover, such an arrangement of the deformation portion is space-saving.

Preferably, the blocking element is designed in one piece and/or produced in one piece. For example, the blocking element can be designed as a cast part or injection-moulded part.

Blocking elements designed in one piece can be easily recycled after use, i.e. when the deformation portion is plastically shortened. For example, used blocking elements can be melted down and processed to form new blocking elements.

The blocking element can be produced from synthetic material or metal material, e.g. from an aluminium alloy.

In one embodiment, the deformation portion extends over a portion of the arc circumferential direction at a centre point angle of 15 degrees to 90 degrees. Depending upon the application, it is thus possible to set a suitable circumference-wise length of the deformation portion. In other words, it is possible to set a suitable length of a braking distance for the saw blade. This ensures that the saw blade comes to a standstill reliably and within a specified time period.

Exemplary deformation portions extend over a portion of the are circumferential direction at a centre point angle of ca. 40 degrees, ca. 45 degrees, ca. 50 degrees, ca. 55 degrees or ca. 60 degrees. In another example, the deformation portion extends over a portion of the arc circumferential direction at a centre point angle of ca. 65 degrees, ca. 70 degrees or ca. 75 degrees.

The head portion can be shorter in the arc circumferential direction than the deformation portion. Therefore, a comparatively large installation space can be provided for the deformation portion. As a consequence, the energy to be absorbed by the deformation portion can be absorbed over a comparatively long time period. This reduces the mechanical loading on the remaining components of the sawing device.

In this regard, exemplary head portions extend over a portion of the arc circumferential direction at a centre point angle of ca. 20 degrees, ca. 25 degrees, ca. 30 degrees, ca. 35 degrees or ca. 40 degrees.

In one example, the head portion extends over a portion of the arc circumferential direction at a centre point angle of ca. 30 degrees and the deformation portion together with the bearing portion extend over a portion of the arc circumferential direction at a centre point angle of ca. 60 degrees. The deformation portion and the bearing portion are thus together twice as long as the head portion. In this example, the blocking element extends on the whole over a portion of the arc circumferential direction at a centre point angle of ca. 90°.

According to one variant, the head portion protrudes in relation to the arc circumferential direction radially inwards with respect to the deformation portion. When the blocking element is in the mounted state, the deformation portion is at a greater distance from an outer circumference of the saw blade than the head portion. By reason of the comparatively shorter distance, the head portion can engage quickly and reliably into the saw blade. Furthermore, the distance of the deformation portion from the outer circumference of the saw blade can be selected such that even when the deformation portion is in a plastically deformed state, it is still spaced apart from the saw blade. In this way, the plastic shortening of the deformation portion is not hindered by any contact between the deformation portion and the outer circumference of the saw blade, in particular the teeth. The distance of the deformation portion from the outer circumference of the saw blade and/or a drive shaft of the saw blade can be designed in different sizes for different blocking elements which are provided for use in different sawing devices.

Therefore, the blocking element can be adapted to different sawing devices having different saw blades.

In the particular region of the head portion which protrudes radially inwards with respect to the deformation portion, an engagement portion or saw portion can be provided for the saw blade. This portion is specifically adapted to reliably couple the saw blade with the head portion. For this purpose, the engagement portion or saw portion can comprise a material which can be sawn particularly easily. This results in a smooth coupling between the saw blade and head portion, i.e. a smooth transition from a non-coupled to a coupled state of the saw blade and head portion.

Furthermore, provision can be made that the head portion comprises regions of different rigidity and/or different ductility. This can be effected by a corresponding arrangement of cavities and/or materials. The cavities can be designed as holes or bores. Alternatively, different rigidities can be achieved by corresponding shaping of the head portion. Therefore, in both variants a region of the head portion which is sawn first when the head portion engages into the saw blade can be provided with comparatively low rigidity and/or ductility. Subsequently sawn regions can be provided with greater rigidity and/or greater ductility. Therefore, a coupling of the saw blade to the head portion is produced in a smooth manner. At the same time, the coupling, once produced, is comparatively strong and so large forces can be transmitted.

In one embodiment, the head portion comprises regions of different materials. As already explained, different materials provide regions of different rigidity and/or different ductility within the head portion. In this regard, a comparatively soft material, e.g. synthetic material, can be used for example in the region of an end of the head portion facing the saw blade and/or in a region located within a saw blade plane. Consequently, a comparatively small cutting force is required to saw into this region, resulting in a smooth sawing action. Further regions can comprise a metal material.

In one example, the head portion has a guide surface for urging the head portion in the direction of the saw blade. The guide surface has a normal with an extension component radially outwards. The radial direction is defined in relation to the arc circumferential direction. The urging comprises in particular an application of force. The head portion can thus be urged by force in the direction of the saw blade, thus producing a reliable coupling between the saw blade and the head portion for the purpose of braking the saw blade. The guide surface can be planar. Alternatively, the guide surface comprises a portion of a circular cylinder lateral surface. The guide surface is thus curved. In both cases, the guide surface can be designed in such a way that when the head portion is coupled to the saw blade, self-reinforcement occurs, i.e. the guide surface continues to urge the head portion in the direction of the saw blade.

The head portion can have a greater rigidity in the arc circumferential direction than the deformation portion. Therefore, when the blocking element is used the deformation portion is deformed in a targeted manner. The kinetic energy of the rotation of the saw blade is thus absorbed in a targeted manner by the deformation portion. In comparison, the head portion is deformed to a lesser extent. In particular, the rigidities of the head portion and deformation portion can be set such that the head portion is substantially not deformed. In one example, a rigidity of the head portion is twice as great as a rigidity of the deformation portion.

It is understood that the deformation portion is designed to absorb substantially all of the kinetic energy of the rotation of the saw blade. Of course, a proportion of the kinetic energy is, however, also absorbed by the sawing of the head portion as well as by a deformation of the head portion. However, the proportion of kinetic energy absorbed by the head portion is comparatively small or even negligible compared to the proportion absorbed by the deformation portion.

According to one variant, the deformation portion comprises a structure with desired deformation points which is plastically deformable in the arc circumferential direction. A plastic shortening of the deformation portion is thus achieved by virtue of the fact that the deformable structure is plastically deformed. In particular, the deformation takes place in the region of the desired deformation points. This produces a well-defined deformation of the deformation portion. In other words, the deformation portion is prevented from being displaced into undesired regions in the course of its plastic shortening, e.g. is prevented from bulging or buckling in an undesired manner.

In particular, the plastically deformable structure comprises structural elements which are designed to fold, fold over or collapse when a force is applied. Such structural elements can extend along the flow of force and/or obliquely and/or transversely to the flow of force. It is also possible for the plastically deformable structure to comprise a plastically compressible material. One example of a plastically compressible material is a porous material, such as a foam material.

The deformation portion can have a plurality of cavities. The cavities are arranged adjacently in the arc circumferential direction. The cavities are to be understood to be macroscopic cavities. The cavities thus form a row in the arc circumferential direction. Of course, it is possible to also provide two or more rows of cavities. Furthermore, the cavities are used to be folded up or collapsed in the arc circumferential direction and thus to convert the kinetic energy resulting from the rotation of the saw blade into a plastic deformation of the deformation portion. By means of the number, arrangement, shape and size of the cavities, it is possible to set the deformation behaviour of the deformation portion in a targeted manner.

In one design alternative, the cavities are continuous in one direction which extends axially in relation to the arc circumferential direction. The cavities are thus open on both axial sides and hence constitute through-going openings. Such cavities can be produced particularly easily. Moreover, such cavities can be folded up or collapsed in a particularly effective manner in order to absorb energy.

On the one hand, the cavities can be manufactured subtractively. In this regard, the cavities are provided, starting from an at least partially solid deformation portion, by means of material removal. The cavities can be produced by cutting-out, punching-out, milling, drilling or other suitable manufacturing methods. On the other hand, the cavities can be introduced into the deformation portion even during production thereof. In the event that the deformation portion is produced by means of a casting or injection-moulding method, the cavities can be provided even by means of this casting or injection-moulding method.

In this regard, a group of cavities can also be referred to as a cavity pattern or pattern of cavities.

In one variant, at least one cavity is defined by a wall having a constant wall thickness. Such cavities can be collapsed or folded up in a particularly reliable manner. This is dependent upon the direction of the application of force, the shape of the cavity and the wall thickness. In particular, the wall thickness can be used to set the force which is required to collapse or fold up the cavity. The wall thickness can thus be varied in order to adapt the blocking element to different sawing devices. Furthermore, constant wall thicknesses are favourable in particular for producing the deformation portion by means of a casting or injection-moulding method.

The fact that a cavity or a plurality of cavities have a constant wall thickness in each case does not preclude the provision of cavities with different wall thicknesses within the deformation portion. In particular, in this regard wall thicknesses can be varied in order to set a rigidity of the deformation portion. A rigidity progression can also be provided within the deformation portion.

The cavities can be formed by means of adjacently arranged ring segments. Such ring segments can be folded up or collapsed in a defined manner in the arc circumferential direction and as a consequence kinetic energy can be converted into a plastic deformation in a defined manner. The ring segments can be spaced apart from one another, directly adjacent to one another or nested one inside the other.

In one example, a deformation portion which is provided with a single row of cavities comprises 5 to 20 ring segments. A first preferred embodiment has seven ring segments. A second preferred embodiment comprises eleven ring segments.

In one exemplified embodiment, at least one of the cavities has a circular, crescent moon-shaped or polygonal cross-section. In this regard, a crescent moon shape is understood to be a differential surface of two overlapping circular surfaces. The cross-sectional shape of the cavities defines a ratio of a length of the deformation portion in a non-deformed state and in a plastically deformed state. By selecting the cross-sectional shape, it is therefore possible to set the extent to which the deformation portion is shortened plastically when force is correspondingly applied.

In this regard, the cavities of ring segments having a circular or circular segment-shaped cross-section are defined by a wall which is circular cylinder jacket-shaped at least in sections. In the case of cavities having a polygonal cross-section, the associated wall has the shape of a jacket of a cylinder having a polygonal base surface. In the case of such ring segments, it is particularly advantageous if at least one corner of the cross-section faces radially inwards or radially outwards in relation to the arc circumferential direction. Such ring segments can be folded up in the arc circumferential direction with particular precision.

In a case in which the deformation portion comprises a row of ring segments and at the same time the deformation portion in a plastically deformed state, i.e. in an end position of the blocking element, is intended to be at a distance of greater than zero from the outer circumference of the saw blade, an extension of the deformation portion which is radial in relation to the arc circumferential direction can be calculated as the sum of half of the inner circumference of the cavity and twice the wall thickness of the associated ring segment. This is based upon the notion that the ring segment is compressed in the circumferential direction in such a way that the cavity is completely closed. In order to ensure a distance from the outer circumference of the saw blade, the radial extension of the deformation portion in its deformed state must be smaller than a radial distance between the outer circumference of the saw blade and the guide element.

A filling material can be arranged in the interior of at least one cavity. The filling material can also be referred to as an inlay. Preferably, the filling material is different from the particular material, from which the deformation portion is produced per se. The filling material can be elastically and/or plastically deformable. As a consequence, the filling material can be used to further set a rigidity of the deformation portion and thus its deformation behaviour. A filling material can be arranged in a single cavity, in a group of cavities or in all cavities.

Furthermore, the deformation portion can have a rigidity progression. Therefore, a rigidity of the deformation portion is not constant in the arc circumferential direction. This can be achieved by virtue of the fact that adjacent portions, e.g. adjacent ring segments, of a plastically deformable structure of the deformation portion have different rigidities. In a first example, the deformation portion bas a lower rigidity at an end facing the head portion than at an end facing the bearing portion. In a second example, it is the other way round, i.e. the deformation portion has a higher rigidity at an end facing the head portion than at an end facing the bearing portion. In both cases, a rigidity progression serves to introduce the kinetic energy arising from the rotation of the saw blade and the associated forces into the deformation portion smoothly and without any jerking. The saw blade is thus braked smoothly. At the same time, a strong braking effect can be guaranteed by means of a rigidity curve which has a large gradient.

The object is also achieved by a sawing device having a circular disc-shaped saw blade and an emergency brake unit. The emergency brake unit comprises a blocking element in accordance with the present invention. The blocking element is mounted on the sawing device such that it can engage selectively into the saw blade in order to brake the saw blade. It is thus selectively possible for the kinetic energy of the rotation of the saw blade to be converted reliably and purposefully into a plastic shortening of the deformation portion. Therefore, rotation of the saw blade can be stopped in a comparatively short time. The forces resulting from the braking of the saw blade are absorbed by the deformation portion of the blocking element in a reliable and targeted manner. As a consequence, only comparatively small forces act upon the remaining components of the emergency brake unit. The same applies to components of the associated sawing device. As a result, the remaining components of the emergency brake unit and the components of the sawing device are not influenced in terms of their functional efficiency by an emergency braking procedure brought about by the blocking element. This applies in particular to the saw blade, which can continue to be used when the sawing device is put back into operation.

The emergency brake unit is coupled in the mounted state to a sensor unit for detecting actual or imminent contact by a user and is operated in dependence upon a detection result of the sensor unit. In this manner, the emergency brake unit can be triggered in a timely and targeted manner so that injury to the user can be completely prevented or at least the severity thereof can be limited.

Furthermore, the emergency brake unit comprises an actuator which can be triggered selectively, in particular in dependence upon the detection result. The actuator is coupled to the blocking element, or more precisely to the associated head portion, and so it can be brought quickly and reliably into engagement with the saw blade. The actuator comprises e.g. a lifting magnet or a shape memory alloy actuator.

In a normal position, the blocking element can be arranged in parallel with a circumference of the saw blade. This means that the portions forming the blocking element are each at a constant radial distance from the saw blade along an outer circumference of the saw blade. In particular, the head portion and the bearing portion of the blocking element are substantially at the same radial distance from the central axis of the saw blade and from the outer circumference of the saw blade along the outer circumference of the saw blade. Furthermore, in this regard a central axis of the arcuate deformation portion and an axis of rotation of the saw blade preferably coincide substantially. The normal position is defined by virtue of the fact that the blocking element is in a position ready for operation, but has not yet been brought into engagement with the saw blade, i.e. the emergency brake unit has not yet been triggered. On the whole, the blocking element is thus positioned on the one hand in a space-saving manner within the sawing device and on the other hand is arranged in such a way that the head portion of the blocking element only has to overcome a comparatively small distance in order to engage into the saw blade. As a result, the saw blade can be brought to a standstill comparatively quickly.

In the normal position, a radial distance of the deformation portion from the saw blade can be greater than a radial distance of the head portion from the saw blade. As already explained, this prevents undesired interactions between the deformation portion and the saw blade.

In an end position of the blocking element, the deformation portion can be spaced apart radially from the saw blade. An end position of the blocking element is to be understood to be a position of the blocking element it occupies after it has engaged into the saw blade and has braked its rotation until it comes to a standstill. The end position thus relates to a position after emergency braking has been effected. Thus, the deformation portion does not come into contact with the saw blade. In this manner, the deformation portion can be plastically deformed without it being influenced by the saw blade. Furthermore, no sawing is effected on or into the deformation portion. Thus, it remains structurally intact and so it can convert kinetic energy effectively into plastic deformation.

Moreover, the blocking element can selectively be disassembled separately from an actuator unit of the emergency brake unit and/or separately from a control unit of the emergency brake unit of the sawing device. The phrase “can be disassembled separately from the actuator unit and/or separately from a control unit” means that the blocking element can be disassembled from the sawing device without the actuator unit and/or the control unit of the emergency brake unit having to be disassembled at the same time. Of course, this does not include mounting elements, bearing elements, holding elements and fastening elements, by means of which the blocking element is mounted. In other words, the blocking element can be singularly disassembled in relation to the actuator unit and/or the control unit. Therefore, the blocking element can be replaced by itself or singularly. The actuator unit and/or the control unit of the emergency brake unit remain mounted on the sawing device when such a replacement occurs. As a result, the blocking element can be disassembled rapidly and simply. In principle, this applies to all operating states of the sawing device and the emergency brake unit, but in particular to a state after triggering of the emergency brake unit, i.e. when the blocking element engages or has engaged into the saw blade. Therefore, the emergency brake unit and the sawing device can be returned into operation rapidly and simply after the triggering of the emergency brake unit. A machining task can thus be continued and completed promptly. The fact that the blocking element can be replaced singularly also ensures that the triggering of the emergency brake unit and the act of making the triggered emergency brake unit ready for operation incur comparatively low costs.

In a preferred embodiment, the blocking element can be disassembled separately from all of the remaining components of the emergency brake unit. In other words, the blocking element can be singularly disassembled in relation to all of the remaining components of the emergency brake unit. The effects and advantages explained are particularly clearly apparent.

In a further preferred embodiment, the blocking element, the actuator unit and the control unit of the emergency brake unit can each be disassembled separately from all of the remaining components of the emergency brake unit. In other words, the blocking element can be singularly disassembled in relation to all of the remaining components of the emergency brake unit. In addition, the actuator unit can be singularly disassembled in relation to all of the remaining components of the emergency brake unit. Moreover, the control unit of the emergency brake unit can be singularly disassembled in relation to all of the remaining components of the emergency brake unit. Therefore, individual components of the emergency brake unit can be replaced, repaired and/or maintained in a simple manner.

In a first alternative, the control unit of the emergency brake unit can be integral with a motor control unit which is used to control a drive motor configured for driving the saw blade. In a second alternative, the motor control unit and the control unit of the emergency brake unit are formed separately. However, they can be connected by signal technology to each other, and so the drive motor can be simply and reliably deactivated when the emergency brake unit is triggered.

The invention will be explained hereinafter with the aid of various exemplified embodiments which are illustrated in the attached drawings. In the figures:

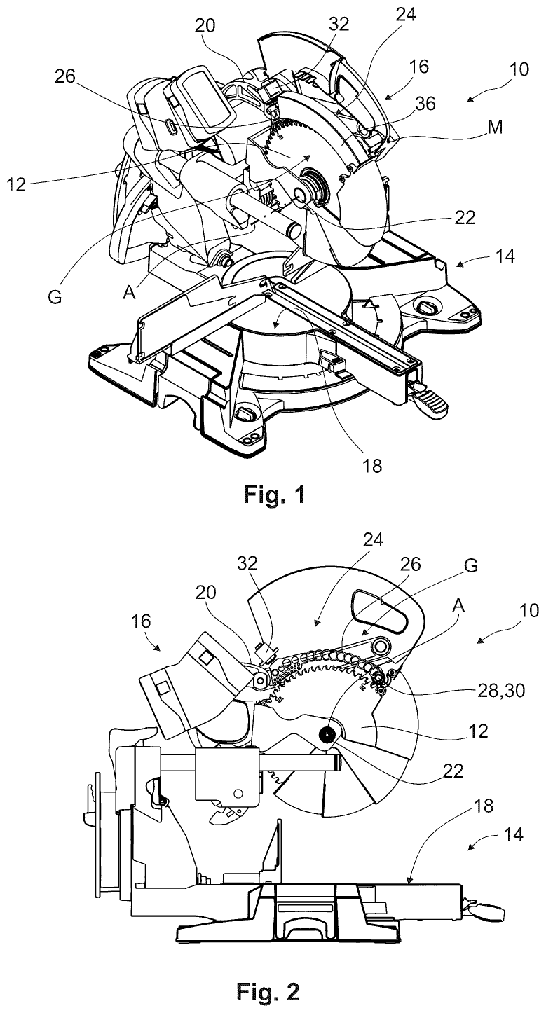

FIG. 1 shows a perspective view of a sawing device in accordance with the invention, wherein the sawing device in accordance with the invention comprises an emergency brake unit which is equipped with a blocking element in accordance with the invention,

FIG. 2 shows the sawing device of FIG. 1 in a side view, wherein a guide element of the emergency brake unit is left out,

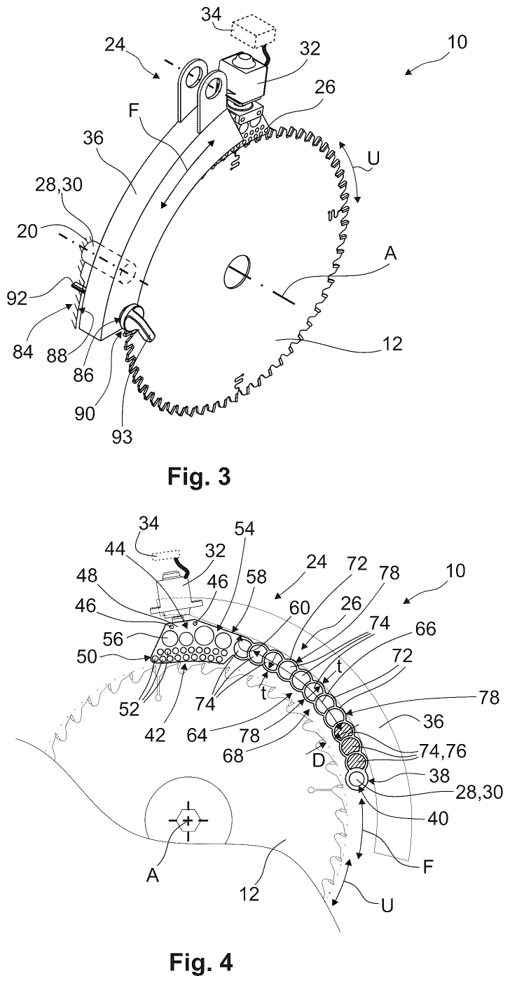

FIG. 3 shows parts of the sawing device of FIGS. 1 and 2 in a separate view,

FIG. 4 shows a detailed view of the blocking element,

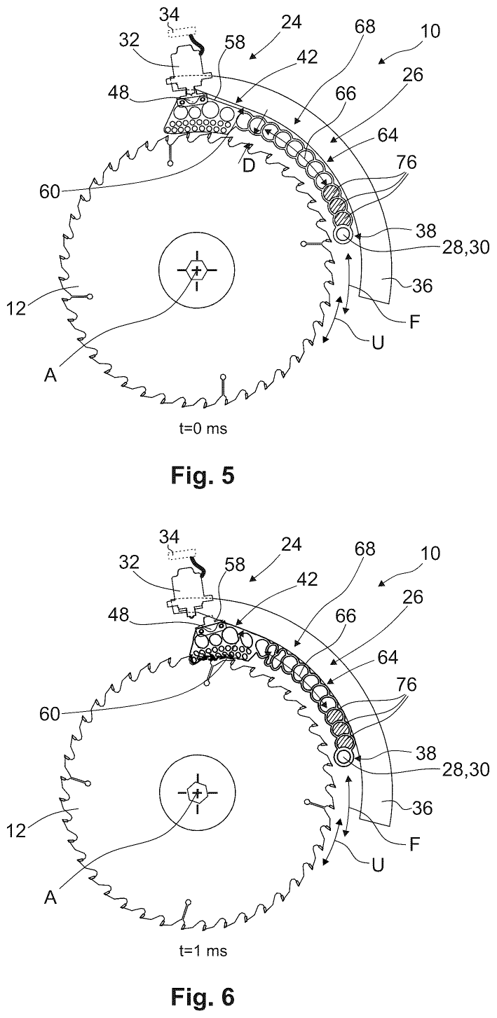

FIGS. 5 to 8 show parts of the sawing device of FIGS. 1 and 2 at different points in time after the triggering of the emergency brake unit,

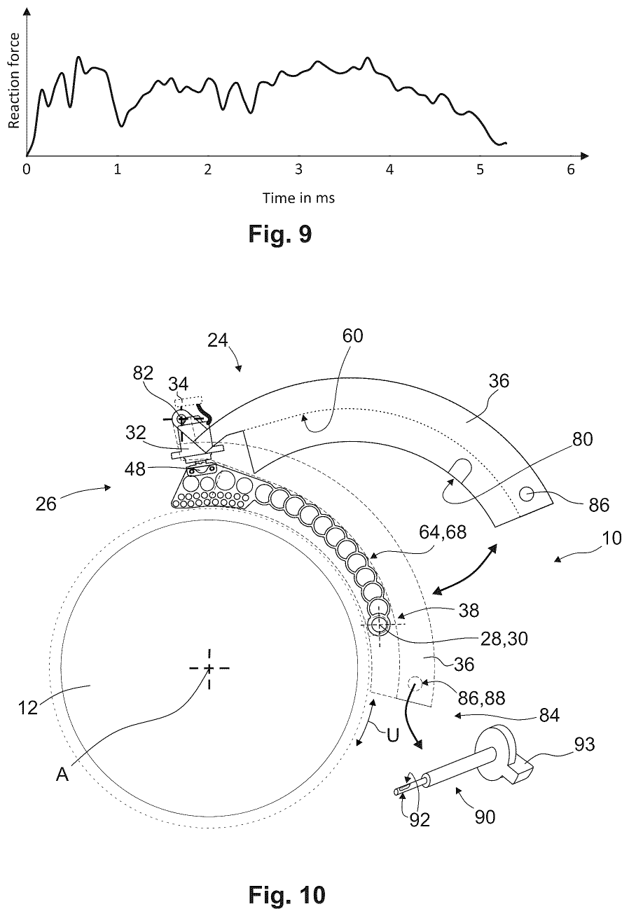

FIG. 9 shows a curve of a force, which is absorbed by the blocking element, over time after the triggering of the emergency brake unit,

FIG. 10 shows parts of the sawing device of FIGS. 1 and 2 during mounting of the blocking element,

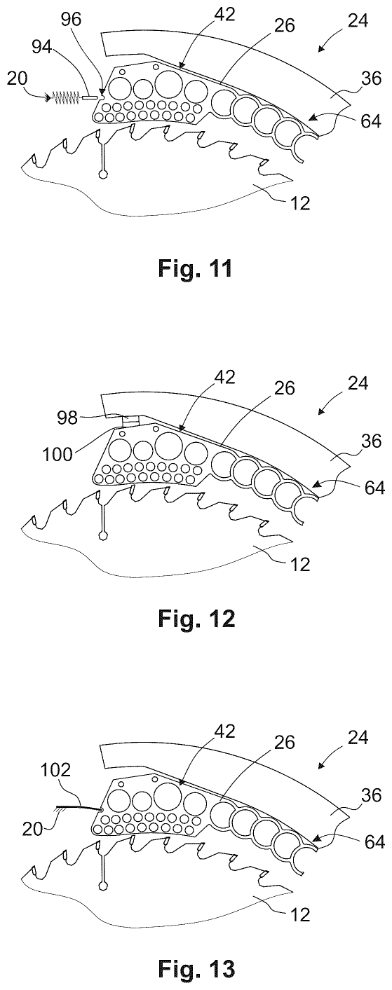

FIGS. 11 to 14 show alternative embodiments for holding the blocking element in a normal position,

FIG. 15 shows parts of a sawing device according to an alternative embodiment,

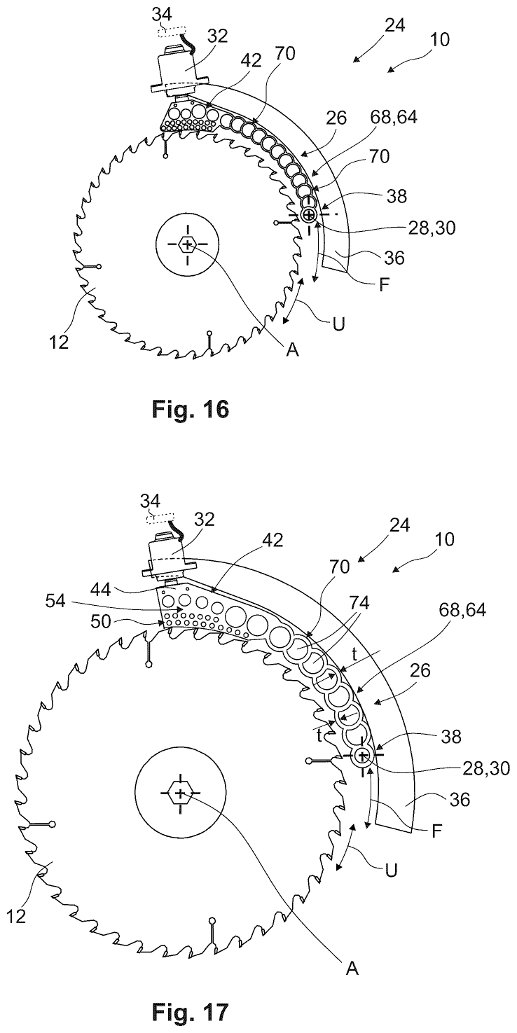

FIG. 16 shows parts of a sawing device according to another alternative embodiment,

FIG. 17 shows parts of a sawing device according to a further alternative embodiment, and

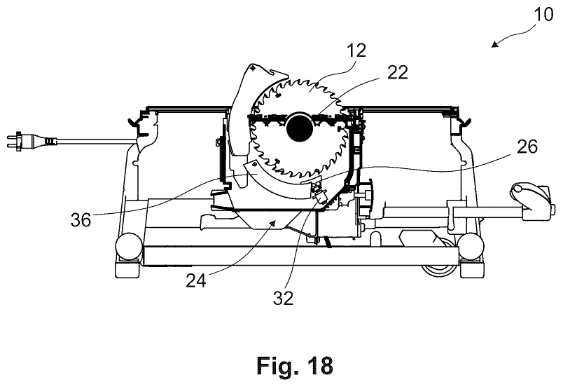

FIG. 18 shows an additional embodiment of a sawing device in accordance with the invention.

FIGS. 1 and 2 show a sawing device 10 having a circular disc-shaped saw blade 12. In the illustrated example, the sawing device 10 is a mitre saw.

The sawing device 10 comprises a base assembly 14 and an arm assembly 16 rotatably mounted thereon.

The base assembly 14 has a support surface 18 on which a component to be machined, i.e. to be sawn off or sawn, can be positioned.

Furthermore, the saw blade 12 can be set in rotation about a central axis A by actuating a drive motor M coupled thereto and can be brought into interaction with the component to be machined by displacing the arm assembly 16 relative to the base assembly 14.

In the example shown, the displacement of the arm assembly 16 relative to the base assembly 14 is effected manually.

The arm assembly 16 or, more generally, the sawing device 10 comprises a frame 20, on which a drive shaft 22 is mounted so as to be able to be driven rotationally. The drive shaft 22 is drivingly coupled to the drive motor M. The saw blade 12 is fixed on the drive shaft 22 and so the saw blade 12 can be rotationally driven in a known manner.

Furthermore, the sawing device 10 is equipped with an emergency brake unit 24 which can be seen in detail in FIGS. 3 and 4.

In order to be able to see the emergency brake unit 24 more clearly, a housing part is not illustrated in a region G in FIGS. 1 and 2. On the one hand, such a housing part serves to remove workpiece particles, e.g. sawdust or dust generated by the use of the sawing device 10. On the other hand, a portion of the handle provided at the end of the arm assembly 16 is formed by means of such a housing part in the illustrated embodiment. Furthermore, the housing part serves to cover the saw blade 12.

The emergency brake unit 24 comprises a blocking element 26 which is mounted on the sawing device 10 so as to be able to rotate via a bearing element 28 fixed to the frame 20 and in the form of a fixed bearing pin 30 such that it can selectively engage into the saw blade 12 in order to brake the saw blade 12.

Moreover, the emergency brake unit 24 comprises an actuator unit 32 which is configured to bring the blocking element 26 selectively into engagement with the saw blade 12.

In the illustrated example, the actuator unit 32 comprises for this purpose an electrically activatable lifting magnet which is not illustrated in greater detail in the figures. The emergency brake unit 24 also comprises an associated control unit 34.

In the illustrated embodiment, the control unit 34 is designed and arranged separately from the actuator unit 32 (see e.g. FIGS. 3 to 8). The actuator unit 32 and the control unit 34 are coupled by signal technology via a signal line.

This configuration ensures that the actuator unit 32 and the control unit 34 can be disassembled separately from one another. This makes replacement, repair or maintenance easier.

The control unit 34 is coupled to a sensor unit, which is known per se, in order to detect when a user actually contacts or is about to contact the saw blade 12.

Therefore, the actuator unit 32 can be operated in dependence upon a detection result of the sensor unit.

Furthermore, the emergency brake unit 24 has a guide element 36 which is mounted on the frame 20 and guides a movement of the blocking element 26 in a guide direction F, as will also be explained in detail hereinafter.

The blocking element 26 is located in a normal position in FIGS. 3 and 4. In this position, the blocking element is arranged in parallel with a circumferential direction U of the saw blade 12.

The blocking element 26 is constructed of three portions 26.

The blocking element 26 comprises a bearing portion 38.

In the illustrated embodiment, the bearing portion 38 is sleeve-shaped, i.e. the bearing portion 38 comprises a circular-cylindrical bearing opening 40 which is defined by a wall 41 having a substantially constant wall thickness.

The fixed bearing pin 30 is received in the bearing opening 40 and so the blocking element 26 is mounted on the frame 20 of the sawing device 10 so as to be able to rotate via the bearing portion 38 and the bearing pin 30.

Furthermore, the blocking element 26 comprises a head portion 42.

The head portion 42 is provided at an end of the blocking element 26 opposite the bearing portion 38.

The head portion 42 is designed, in the event of an actuation of the emergency brake unit 24, i.e. driven by the actuator unit 32, to engage into the saw blade 12 in order to brake said saw blade ideally until it comes to a standstill.

In this regard, the head portion 42 comprises a coupling portion 44.

The coupling portion 44 is positioned at an end of the blocking element 26 opposite the bearing portion 38.

Moreover, the coupling portion 44 is positioned radially on the outside on the head portion 42.

The coupling portion 44 serves two different functions.

Firstly, the coupling portion 44 is designed to introduce an actuating force generated by the actuator unit 32 into the blocking element 26 and so the head portion 42 can engage into the saw blade 12.

Secondly, the coupling portion 44 serves to fix or retain the blocking element 26 at least in the normal position, shown in FIGS. 3 and 4, with respect to the frame 20. Therefore, the head portion 42 in the normal position is prevented from engaging into the saw blade 12.

The functions of the introduction of force and the retention can be implemented separately from one another or collectively, i.e. in combination. The latter is the case in the embodiments shown in FIGS. 1 to 10.

In this case, the coupling portion 44 comprises two coupling openings 46.

In addition, a U-shaped form-fitting element 48 is provided which on the one hand is fastened to the actuator unit 32, e.g. in a form-fitting manner, and which on the other hand has nubs which are complementary to the coupling openings 46 and engage into the coupling openings 46. The form-fitting element 48 is thus coupled in a form-fitting manner both to the blocking element 26 and also to the actuator unit 32.

Thus, on the one hand, an actuating force generated by the actuator unit 32 can be introduced into the blocking element 26 via the form-fitting element 48. On the other hand, the blocking element 26 is retained in the normal position relative to the frame 20 via the form-fitting element 48 and the actuator unit 32.

It is understood that, alternatively, the coupling openings 46 and the allocated nubs can also be omitted. Instead of the U-shaped form-fitting element 48, a likewise U-shaped clamping element is then used which is fixedly clamped on the coupling portion 44, i.e. is connected in a force-fitting manner to the blocking element 26 in the region of the coupling portion 44. The fastening of such a clamping element to the actuator unit 32 can be effected in a form-fitting or force-fitting manner.

Furthermore, the head portion 42 comprises a cutting zone 50.

In the illustrated embodiment, the cutting zone 50 is characterised by a two-row pattern of through-going openings 52. For improved clarity, only some of the through-going openings 52 are provided with a reference sign in the figures.

By means of the through-going openings 52, the material of the head portion 42 is weakened specifically in the region of the cutting zone 50 and so, after triggering of the emergency brake unit 24, the saw blade 12 cuts into the head portion 42 smoothly and over as large a region of said head portion as possible.

This results in a reliable coupling between the saw blade 12 and the blocking element 26 which is necessary in order to reliably brake rotation of the saw blade 12.

A connecting zone 54 is provided substantially between the coupling portion 44 and the cutting zone 50.

In the illustrated embodiment, the connecting zone 54 also comprises through-going openings 56. Again, for improved clarity, only some of the through-going openings 56 are provided with a reference sign in the figures. However, the diameters of the through-going openings 56 of the connecting zone 54 are selected to be considerably larger than the diameters of the through-going openings 52 of the cutting zone 50.

The connecting zone 54 serves on the one hand to transmit an actuating force from the coupling portion 44 to the cutting zone 50. On the other hand, the cutting zone 50 is coupled to the deformation portion, which will be explained hereinafter, via the connecting zone 54.

In this regard, the through-going openings 56 of the connecting zone 54 serve to ensure sufficient rigidity of the connecting zone 54 with the lowest possible mass and thus the lowest possible mass inertia.

Moreover, the head portion 42 is equipped with a guide surface 58.

The guide surface 58 lies against a counter guide surface 60 of the guide element 36.

By reason of the geometry of the head portion 42 and the counter guide surface 60, a force is applied to the head portion 42 in the direction of the saw blade 12 when said head portion is moved clockwise in the circumferential direction U of the saw blade 12 in the view shown in FIG. 4. For this purpose, the guide surface 58 has a normal with an extension component radially outwards.

As is apparent from the explanations above, in the case of the head portion 42 shown in the figures through-going openings are used in order to create regions of different rigidity and different resistances to cutting by the saw blade 12. It is understood that, as an alternative to the through-going openings, this can also be achieved by providing different materials in the different regions of the head portion 42. In this regard, it may be particularly important to use materials of different ductility.

Located between the head portion 42 and the bearing portion 38, the blocking element 26 comprises a deformation portion 64.

The deformation portion 64 connects the bearing portion 38 and the head portion 42 to one another.

On the whole, the deformation portion 64 is arcuate and in the illustrated exemplified embodiment it is circular arc-shaped.

In this case, an arc circumferential direction 66, i.e. the curved longitudinal extension direction of the arc-shaped deformation portion 64, extends substantially in parallel with the circumferential direction U of the saw blade 12.

In the illustrated embodiment, an outer circumference of the saw blade 12 and the arcuate deformation portion 64 also extend concentrically, wherein the central axis A constitutes the centre.

In the embodiment illustrated in FIG. 4, the deformation portion 64 extends over a portion of the arc circumferential direction 66 at a centre point angle of ca. 60 degrees.

Therefore, the circumferential extension of the deformation portion 64 is essentially twice the circumferential extension of the head portion 42. As a consequence, the head portion 42 is circumferentially shorter than the deformation portion 64.

The deformation portion 64 is also multiple times longer in relation to a circumferential extension of the bearing portion 38.

Moreover, in a radial direction in relation to the central axis A of the saw blade 12, the deformation portion 64 is spaced further apart from the outer circumference of the saw blade 12 than the head portion 42 and the bearing portion 38 are.

In other words, both the head portion 42 and the bearing portion 38 project radially inwards in relation to the deformation portion 64 with respect to the arc circumferential direction 66.

In this regard, the radial distance D of the deformation portion 64 from the saw blade 12 is selected such that it is greater than zero in all operating situations of the emergency brake unit 24. This also applies in particular to an end position of the blocking element 26 to be explained later.

In other words, the distance D of the deformation portion 64 is selected such that it does not contact the outer circumference of the saw blade 12 in any operating situation.

The deformation portion 64 further comprises a structure 68 which can be plastically deformed in the arc circumferential direction 66.

In the embodiment illustrated in FIG. 4, this structure 68 is formed from a total of eleven ring segments 70.

The ring segments 70 are arranged in the arc circumferential direction 66 in an adjacent manner with a slight overlap.

Each of the ring segments 70 has a wall 72 having a substantially constant wall thickness t.

The walls 72 define in each case an axially continuous cavity 74.

For improved clarity, only some of the ring segments 70 and only some of the walls 72 and some of the cavities 74 are provided with a reference sign in the figures.

The structure 68 which can be plastically deformed in the arc circumferential direction 66 thus comprises a total of eleven cavities 74 which are arranged in an adjacent manner in the arc circumferential direction 66.

The slight overlap of the ring segments 70 produces a crescent moon-shaped cross-section for each cavity 74.

Furthermore, a filling material 76 is arranged in each case in the interior of the three cavities 74 which are arranged adjacent to the bearing portion 38.

In the illustrated embodiment, the filling material is a rubber material.

For the remainder, the blocking element 26 is produced from an aluminium alloy.

The filling material 76 gives rise to a different rigidity of the deformation portion 64 in the region of the cavities 74 provided with the filling material 76 than in the region of the unfilled cavities 74. The deformation portion 64 thus comprises two regions having different rigidities or, more generally, a rigidity progression.

It is understood that the rigidity can be set in a targeted manner by a corresponding selection of the filling material 76 and the number and position of the cavities 74 filled with the filling material 76.

The overall effect of the structure 68 is that a rigidity of the deformation portion 64 in the arc circumferential direction 66 is smaller than a rigidity of the head portion 42.

In addition, the structure 68 has desired deformation points 78. In the embodiment illustrated in FIG. 4, they are located in each case in the portions of the ring segments 70 which protrude radially inwards to the furthest extent and in the portions thereof which protrude radially outwards to the furthest extent.

Once again, for improved clarity, only some of the desired deformation points 78 are provided with a reference sign in the figures.

The deformation portion 64 is thus designed to be plastically shortened in order to brake the saw blade 12 in the arc circumferential direction 66. This will be explained hereinafter with reference to FIGS. 5 to 8.

In this regard, FIG. 5 shows the emergency brake unit 24 and in particular the blocking element 26 in the already described normal position. This means that the actuator unit 32 has not yet been actuated in order to effect emergency braking.

Accordingly, a force also does not yet act upon the blocking element 26 (cf. FIG. 9).

As has already been explained, the blocking element 26 is held in the normal position via the form-fitting element 48 and the actuator unit 32.

The position in FIG. 5 corresponds to the situation at 0 milliseconds in the graph of FIG. 9.

It is now assumed that at time zero milliseconds (0 ms) the emergency brake unit 24 is triggered. As a consequence, the actuator unit 32 is actuated and the head portion 42 is urged in the direction of the saw blade 12. In the illustrated exemplified embodiment, this is effected via the form-fitting element 48.

It is understood that at the same time the drive motor M is deactivated and/or decoupled from the drive shaft 22.

FIG. 6 illustrates a situation which arises one millisecond (1 ms) after the triggering. Again, the force curve at 1 ms in FIG. 9 can be allocated to the situation in FIG. 6.

In this situation, the saw blade 12 has cut into the cutting zone 50 and so a force-based coupling is produced between the saw blade 12 and the blocking element 26. By reason of the clockwise rotation of the saw blade 12, at the time illustrated in FIG. 6 the head portion 42 has already been entrained by a certain circumferential distance in the circumferential direction U of the saw blade 12 in contrast to the initial situation of FIG. 5.

This has resulted in the connection between the form-fitting element 48 and the actuator unit 32 being released.

The coupling between the form-fitting element 48 and the head portion 42 has remained in the present case.

It is understood that, alternatively, the connection between the form-fitting element 48 and the head portion 42 can also be disconnected and the connection between the form-fitting element 48 and the actuator unit 32 maintained.

In this regard, the guide element 36 ensures that the blocking element 26 cannot prevent itself from being entrained by the saw blade 12 in either the radial direction or in the axial direction.

The blocking element 26 is thus guided in the guide direction F by means of the guide element 36.

Furthermore, the entrainment by the saw blade 12 has caused at least the three ring segments 70 which are arranged adjacent to the head portion 42 to have deformed.

More precisely, these ring segments have been compressed in the arc circumferential direction 66.

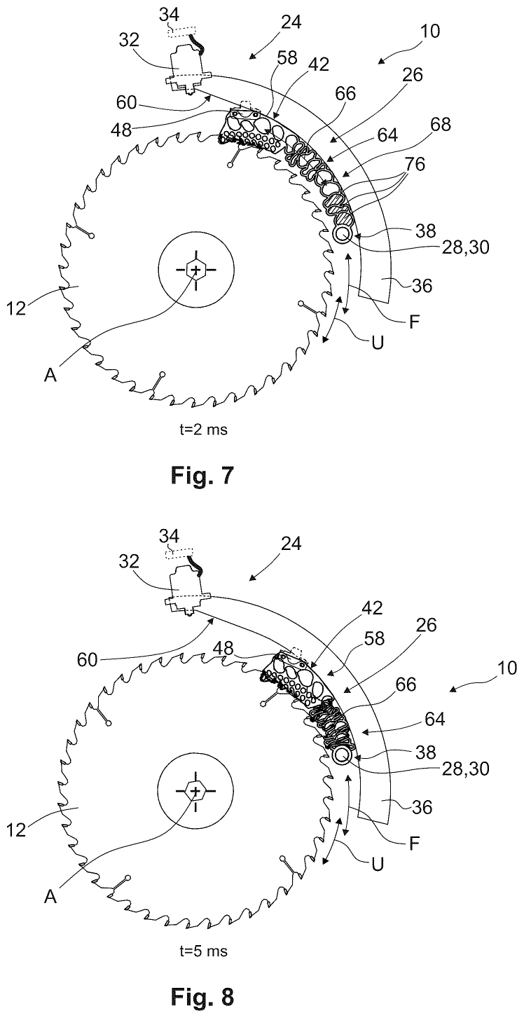

FIG. 7 shows the emergency brake unit 24 after a further millisecond has passed, i.e. 2 milliseconds after the triggering.

The head portion 42 continues to be coupled to the saw blade 12.

Now, however, all ring segments 70 are compressed in the are circumferential direction 66 and so the deformation portion 64 is already significantly plastically shortened in the arc circumferential direction 66.

The kinetic energy of the rotation of the saw blade 12 is converted into the plastic shortening of the deformation portion 64 in order to brake the saw blade 12.

FIG. 8 shows the emergency brake unit 24 five milliseconds (5 ms) after the triggering. At this time, the saw blade 12 is substantially at a standstill, i.e. it no longer rotates.

The deformation portion 64 is now substantially completely compressed, i.e. the cavities 74 are substantially closed by pushing the deformation portion 64 together in the arc circumferential direction 66.

FIG. 8 thus shows the emergency brake unit 24 at the end of the emergency braking procedure. The associated position of the blocking element 26 is also referred to as the end position.

In order to be able to put the emergency brake unit 24 and the sawing device 10 as a whole back into operation, i.e. to make a sawing device 10, of which the emergency brake unit 24 has been triggered, ready for operation once again, the blocking element 26 must now be replaced.

For this purpose, the blocking element 26 can be selectively disassembled from the frame 20 separately from the actuator unit 32. The blocking element 26 can thus be singularly disassembled. This will be explained in conjunction with FIG. 10.

As already explained, the blocking element 26 is mounted on the frame 20 so as to be able to rotate via the fixed bearing pin 30.

In order to prevent the blocking element 26 from being separated from the bearing pin 30 in an axial direction of the bearing pin, a holding element 80 is provided for holding the blocking element 26 on the bearing pin 30.

In the illustrated embodiment, this holding element 80 is a side wall portion of the guide element 36, i.e. a portion of a wall of the guide element 36 which prevents axial displacement of the blocking element 26.

Consequently, if the guide element 36 is in its operating position illustrated as a dashed line in FIG. 10, the blocking element 26 is held on the bearing pin 30.

The guide element 36 is mounted on the frame 20 so as to be able to rotate via a further bearing element 82 which is likewise designed as a bearing pin.

This allows the guide element 36 to be transferred to a release position for disassembly of the blocking element 26, said release position being illustrated by solid lines in FIG. 10. In the release position, the holding element 80 is removed from the bearing element, i.e. from the bearing pin 30.

In order to prevent the guide element 36 from taking up the release position in an undesirable manner, it can be locked in the operating position by means of a locking mechanism 84 (see also FIG. 3 in addition to FIG. 10).

The locking mechanism 84 comprises a first through-going opening 86 on the guide element 36 and a second through-going opening 88 on the frame 20.

Furthermore, the locking mechanism 84 has a locking pin 90.

At a first end, the locking pin 90 is equipped with locking wings 92 and at a second end, opposite the first end, it is equipped with an operating lever 93.

The locking pin 90 can thus be inserted into the through-going openings 86 and 88 and transferred by means of the operating lever 93 into a rotational position in which the locking wings 92 engage behind a portion of the frame 20.

In another rotational position, the rearward engagement is released and so the locking pin can be pulled axially out of the through-going openings 86 and 88.

By means of the locking mechanism 84, the guide element 36 can thus be selectively locked on the frame 20 and selectively unlocked from the frame 20. Of course, this also applies to the holding element 80 formed by the guide element 36.

Therefore, no tool whatsoever is required in order to operate the locking pin 90 and thus to disassemble the blocking element 26.

Therefore, in order to singularly disassemble the blocking element 26, only the locking pin 90 is unlocked and removed from the frame 20. The guide element 36 is then transferred to the release position and the blocking element 26 is removed from the bearing pin 30 in an axial direction thereof, i.e. is disassembled from the frame.

Then, an unused blocking element 26 is mounted.

For this purpose, the bearing portion 38 of the unused blocking element 26 is placed onto the fixed bearing pin 30.

Furthermore, the unused blocking element 26 is coupled to the actuator unit 32.

Then, the guide element 36 is moved back to the operating position and locked at that location by means of the locking pin 90.

Furthermore, the actuator unit 32 must be returned to its starting position. This can be effected by means of the control unit 34.

The sawing device 10 is now ready for operation again and the emergency brake unit 24 is ready for operation again.

In the case of the emergency brake unit 24 illustrated in FIGS. 1 to 10, the head portion 42 is always selectively brought into engagement with the saw blade 12 by the actuator unit 32 and also held by the actuator unit 32 in the normal position such that the head portion 32 does not unintentionally come into contact with the saw blade 12.

FIGS. 11 to 14 show alternatives for the retention of the blocking element 26 in the normal position. The force is applied, as usual, via a pressure piece coupled to the lifting magnet of the actuator unit 32, said pressure piece being formed to apply an actuating force to the head portion 42 in the direction of the saw blade 12. The pressure piece can be formed as a pushrod.

In this regard, in the alternative according to FIG. 11 the blocking element 26 is held in the normal position by means of a spring-loaded pin 94. For this purpose, the spring-loaded pin 94 engages into an associated depression 96 on a circumferential end side of the blocking element 26.

The actuator unit 32 corresponds to the actuator unit 32 of the embodiment from FIGS. 1 to 10. If this is triggered, it urges the blocking element 26 in the direction of the saw blade 12. As a result, the pin 94 is urged out of the depression 96 against the spring force.

In the alternative of FIG. 12, a magnet 98 and a counter piece 100 consisting of ferromagnetic material are provided. In the illustrated example, the magnet is fastened to the guide element 36 and the counter piece is fastened to the head portion 42 of the blocking element 26.

The pairing of magnet 98 and counter piece 100 is selected such that, by means of the actuator unit 32, the head portion 42 and thus the counter piece 100 can be detached from the magnet 98 against a magnetic force when the emergency brake unit 24 is actuated.

In the alternative of FIG. 13, a leaf spring element 102 is fastened to the frame 20 via a first end. A second end of the leaf spring element 102 is received in a depression 104 which is arranged on the end-side on the blocking element 26. The blocking element 26 is thereby held in the normal position.

The actuator unit 32 again corresponds to the actuator unit 32 of the embodiment from FIGS. 1 to 10. If this is triggered, it urges the blocking element 26 in the direction of the saw blade 12. The leaf spring element 102 is thereby deformed, and so its free end springs out of the depression 104 and releases the blocking element.

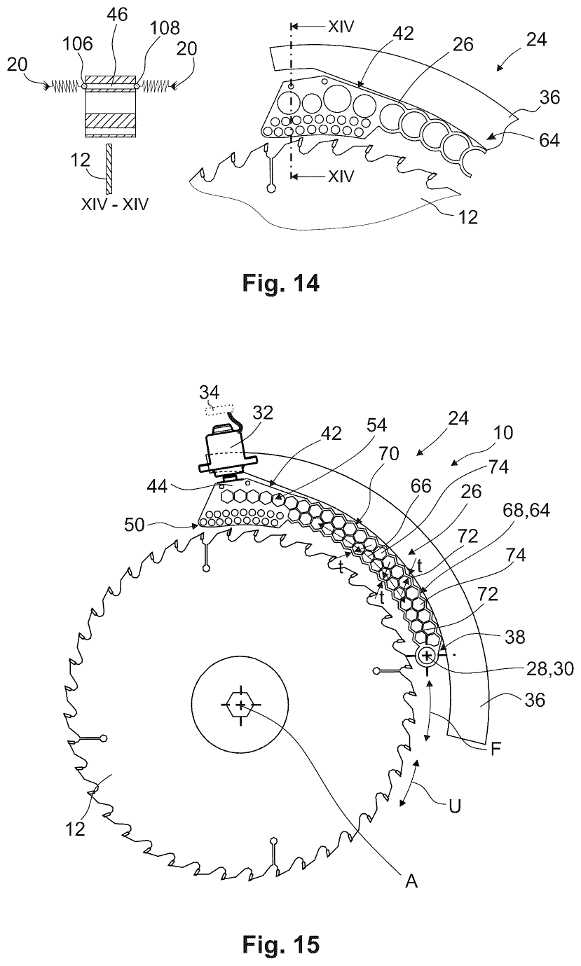

In the alternative of FIG. 14, two balls 106, 108 are provided which each engage at different ends of one of the coupling openings 46.

The balls 106, 108 are spring-loaded and so, when the actuator unit 32 is actuated, they can be urged out of the coupling openings 46 and can thus release the blocking element 26.

FIG. 15 shows sections of an alternative sawing device 10.

Only the differences with respect to the sawing devices 10 already explained will be discussed hereinafter. Identical or mutually corresponding elements are designated by the same reference signs.

The differences relate to the blocking element 26.

Unlike in the previous embodiments, the deformation portion 64 now comprises hexagonal ring segments 70. This means that the walls 72 of the ring segments 70 each form hexagons and the through-going openings 74 which are defined by these walls 72 each form a hexagonal cross-section.

A further difference is that two radially adjacent rows of ring segments 70 are now provided. In addition, each of these rows of ring segments 70 bas 16 ring segments 70. There are therefore more ring segments 70 in each row than e.g. in the blocking element 26 of FIG. 4.

The plastically deformable structure 68 of the blocking element 26 of FIG. 15 can also be referred to as a honey comb structure.

For improved clarity, again only some of the ring segments 70 and only some of the walls 72 and some of the cavities 74 are provided with a reference sign.

The desired deformation points 78 are now formed by those portions of the walls 72 of each ring segment 70 which comprise the corner of the hexagonal cross-section which protrudes radially inwards to the furthest extent and the corner of the hexagonal cross-section which protrudes radially outwards to the furthest extent.

Each ring segment 70 thus comprises two desired deformation points 78, a radially inner one and a radially outer one.

The through-going openings in the head portion 42, or more precisely the through-going openings 56 in the connecting zone 54, now also have hexagonal cross-sections. In addition, they are arranged slightly differently than in the blocking element 26 of FIG. 4.

FIG. 16 shows sections of a further alternative sawing device 10.

Again, only the differences with respect to the preceding embodiments are explained.

The sawing device 10 in FIG. 16 has a considerably smaller saw blade 12 than the sawing devices explained above.

The blocking element 26 does not differ in shape from the blocking element 26 of FIG. 10. It has only been scaled proportionally,

This can be seen in particular by comparing the size of the blocking element 26 and the actuator unit 32 which is identical in the embodiments shown in FIGS. 10 and 16.

FIG. 17 shows sections of another alternative sawing device 10.

Again, only the differences with respect to the preceding embodiments are discussed. They relate again to the blocking element 26.

In the embodiment shown in FIG. 17, the head portion 42 of the blocking element 26 is configured differently.

On the one hand, its end side is no longer pointed but instead is blunt.

On the other hand, this is longer in the arc circumferential direction 66 compared to the previous head portions 42.

This also results in an increased number and changes in the size and position of the through-going bores 56 in the connecting portion 54.

Since the total length of the blocking element 26 in the arc circumferential direction 66 has remained the same, the deformation portion 64 is now shorter. It now comprises a total of only seven ring segments 70. The wall thickness t of the associated walls 72 has been increased in comparison with the embodiment shown in FIG. 4.

For improved clarity, again only some of the ring segments 70 and only some of the walls 72 and some of the cavities 74 are provided with a reference sign.

FIG. 18 shows an additional embodiment of a sawing device 10.

Now, the sawing device 10 is designed as a circular bench saw.

For the remainder, the above explanations apply analogously, in particular with regard to the emergency brake unit 24.

It is noted that in all of the aforementioned embodiments, the actuator unit 32 also can be selectively singularly disassembled from the frame 20. This makes it easy to repair the emergency brake unit 24 in the event that a defect occurs in the actuator unit 32.

The actuator unit 32 can also be disassembled in a tool-free manner.

### LIST OF REFERENCE SIGNS

10 sawing device
12 saw blade
14 base assembly
16 arm assembly
18 support surface
20 frame
22 drive shaft
24 emergency brake unit
26 blocking element
28 bearing element
30 bearing pin
32 actuator unit
34 control unit
36 guide element
38 bearing portion
40 bearing opening
41 wall
42 head portion
44 coupling portion
46 coupling openings
48 form-fitting element
50 cutting zone
52 through-going opening
54 connecting zone
56 through-going opening
58 guide surface
60 counter guide surface
64 deformation portion
66 arc circumferential direction
68 plastically deformable structure
70 ring segment
72 wall
74 cavity
76 filling material
78 desired deformation point
80 holding element
82 bearing element
84 locking mechanism
86 first through-going opening
88 second through-going opening
90 locking pin
92 locking wings
93 operating lever
94 pin
96 depression
98 magnet
100 counter piece
102 leaf spring element
104 depression
106 ball
108 ball
A central axis of the saw blade
D radial distance of the deformation portion from the saw blade
M drive motor
U circumferential direction of the saw blade
F guide direction
G region for a housing part, not illustrated
t wall thickness

1. A blocking element for an emergency brake unit of a sawing device having a circular disc-shaped saw blade, wherein the blocking element comprises:
a bearing portion, via which the blocking element is configured to mount on the sawing device,
a head portion which is designed to engage into the saw blade selectively for braking purposes, and
a deformation portion which is located between the bearing portion and the head portion and/or connects the bearing portion and the head portion to one another,
wherein the deformation portion is arcuate and designed to be plastically shortened in order to brake the saw blade in an arc circumferential direction.

2. The blocking element as claimed in claim 1, wherein the head portion is shorter in the arc circumferential direction than the deformation portion.

3. The blocking element as claimed in claim 1, wherein the head portion protrudes in relation to the arc circumferential direction radially inwards with respect to the deformation portion.

4. The blocking element as claimed in claim 1, wherein the head portion has a greater rigidity in the arc circumferential direction than the deformation portion.

5. The blocking element as claimed in claim 1, wherein the deformation portion comprises a structure with desired deformation points which is plastically deformable in the arc circumferential direction.

6. The blocking element as claimed in claim 1, wherein the deformation portion has a plurality of cavities which are arranged adjacently in the arc circumferential direction.

7. The blocking element as claimed in claim 6, wherein the cavities are continuous in one direction which extends axially in relation to the arc circumferential direction.

8. The blocking element as claimed in claim 6, wherein at least one cavity is defined by a wall having a constant wall thickness.

9. The blocking element as claimed in claim 6, wherein the cavities are formed by means of adjacently arranged ring segments.

10. The blocking element as claimed in claim 1, wherein the deformation portion has a rigidity progression.

11. A sawing device having a circular disc-shaped saw blade and an emergency brake unit, wherein the emergency brake unit comprises a blocking element as claimed in claim 1 which is mounted on the sawing device such that it is configured to engage selectively into the saw blade in order to brake the saw blade.

12. The sawing device as claimed in claim 11, wherein the blocking element is arranged in a normal position in parallel with a circumference of the saw blade.

13. The sawing device as claimed in claim 12, wherein, in the normal position, a radial distance of the deformation portion from the saw blade is greater than a radial distance of the head portion from the saw blade.

14. Sawing The sawing device as claimed in claim 11, wherein, in an end position of the blocking element, the deformation portion is spaced apart radially from the saw blade.

15. The sawing device as claimed in claim 11, wherein the blocking element is configured to selectively disassemble from the sawing device separately from an actuator unit.
